(19) United States
(12) Patent Application Publication
(10) Pub. No.: US 2013/0077171 A1
(43) Pub. Date: Mar. 28, 2013

(54) TUNABLE INTERFERENCE FILTER WITH SHAPING PRISMS

(71) Applicant: YUNG-CHIEH HSIEH, San Jose, CA (US)

(72) Inventor: YUNG-CHIEH HSIEH, San Jose, CA (US)

(73) Assignee: OPTOPLEX CORPORATION, FREMONT, CA (US)

(21) Appl. No.: 13/180,600

(22) Filed: Jul. 12, 2011

Related U.S. Application Data
(60) Provisional application No. 61/399,518, filed on Jul. 12, 2010.

(51) Int. Cl. G02B 5/28

(52) U.S. Cl. 359/578

(57) ABSTRACT

A conventional interference tunable filter is combined with a pair of shaping prisms to enlarge the circular input beam in the direction orthogonal to the direction of beam propagation and to the axis of rotation of the tunable filter. The degree of expansion is tailored to minimize the walk-off losses produced by successive reflections in the cavity of the tunable filter. By appropriately sizing the enlargement, the substantially elliptical beam produced by the shaping prisms encompasses sufficient reflected beams after passing through the tunable filter to produce substantially the same filter output that in a conventional filter would require a materially larger input beam. The input beam is preferably first converted to two parallel beams of the same polarization state. Both beams are then expanded by the prisms and processed by the tunable filter.

### RELATED APPLICATIONS

This application is based on and claims the priority of U.S. Provisional Application Ser. No. 61/399,518, filed Jul. 12, 2010.

### BACKGROUND OF THE INVENTION

1. Field of the Invention

This invention pertains to the general field of tunable interference filters and, in particular, to a tunable filter with improved transmission efficiency.

2. Description of the Prior Art

Tunable interference filters are widely used components of optical systems, in particular in optical communications systems, where information is transmitted along the same optical path at different wavelengths of light (channels). In order to retrieve information contained in a particular channel, the signal wavelengths have to be spectrally separated. Similarly, in order to add a particular channel to the stream of optical information, a spectral addition of a particular wavelength is required. This is achieved in principle using various optical filters that pass at least a portion of the input light within a predetermined spectral range and reflect (stop) at least a portion of the light within another spectral range.

A wide variety of tunable optical filters is known in the art, the most fundamental one being a simple thin-film filter fabricated by depositing a thin-film stack on a suitable substrate. Almost all narrow-band thin-film optical filters depend at least in part on interference for their operation. Therefore, the spectral characteristics of such filters are determined by the mixture of intrinsic optical properties of the filter materials (such as refractive index, reflectance, transmittance, absorbance) and by their geometric arrangement (thickness, for instance).

In general interference filters are multilayer thin-film devices and wavelength selection is based on the property of destructive light interference. This is the same principle underlying the operation of a Fabry-Perot interferometer. Incident light is passed through each pair of coated reflecting surfaces. The distance between the reflective coatings determines which wavelengths interfere destructively and which wavelengths are in phase and will ultimately pass through the coatings. The input beam is bounced back and forth multiple times between each pair of coatings. On the output side of the filter, if these reflected beams are in phase, the light is passed through the reflective surfaces. If, on the other hand, the multiple reflections are not in phase, destructive interference reduces the transmission of these wavelengths through the device to near zero. This process strongly attenuates the transmitted intensity of light at wavelengths that are higher or lower than the wavelength of interest.

The multi-layer structure of a typical interference filter consists of a dielectric spacer material that defines a gap between reflective parallel surfaces; a stack of reflecting thin-film layers defines such at least on one side of the gap. The spacer has a thickness of multiples of one-half wavelength at the desired peak transmission wavelength, thereby producing constructive interference and transmission at that wavelength. The combination of the stack and the spacer comprise a one-cavity passband filter. However, because a single-cavity passband filter does not exhibit a sharp transition between passband and out-of-passband wavelengths, it is common practice to layer several cavities sequentially into a multi-cavity filter design to sharpen the cutoff and reduce the transmission of out-of-band wavelengths.

Spectral tuning of a filtering function (or spectral shifting of the peak wavelength of the pass/stop bands of the filter) in such a tunable filter can be achieved simply by varying the angle of incidence of the input light beam (defined and measured with respect to the normal to the surface of the filter). Variation of the angle of incidence of the input light is most easily accomplished by the physical rotation of the thin-film filter with respect to the incident light.

As illustrated schematically in FIG. 1, when the angle of incidence θ of the input light I with the normal N to the plane of incidence is not zero, the passband light reflected within the etalon structure produces sequential shifts that cause much of the energy to be directed outside the cross-section of the first transmission beam (the so-called “walk-off” effect). For convenience, a single-cavity filter is used for illustration and a system of Cartesian coordinates is provided as a reference throughout this disclosure. One skilled in the art will readily appreciate that the entire disclosure applies equally to multi-cavity filters.

The transmission wavelength of a narrow-band interference filter is a co-sinusoidal function of the angle of the beam inside the spacer.

λ_{θ}≈λ₀ cos(θ), (1)

where θ is the beam angle in the spacer layer; λ₀ and λ_{θ} are the transmitted wavelength when the beam angle in the spacer layer is zero and when it is θ, respectively. This beam angle inside the spacer layer can be related to the angle of incidence (AOI) by Snell's law,

nₒ sin (φ)=nₑ sin(θ), (2)

where nₒ is the refractive index of air, nₑ is the effective refractive index of the spacer, φ is the AOI in air, and θ is the beam angle in the spacer. Thus, the wavelength changes with the AOI and it is longest at normal incidence, decreasing when the AOI increases. At angles of incidence near zero degrees, the transmission wavelength is less affected, but at larger AOIs, such as 20 degrees and more, the transmission wavelength can shift by as much as one picometer for each arc-second change in the AOI (at the range of bassband frequencies, 1525 nm-1565 nm, normally used in the art).

Ideally all reflected beams generated by the input light I interfere constructively in the spacer gap and pass through collinearly in transmission as a single output beam T. However, at large incident angles the walk-off between two adjacent transmission beams becomes significant and subsequent reflections produce transmission beams that are not accounted for in the output, as illustrated in FIG. 1, which greatly affects the filter profile. If the cumulative walk-off is greater than the beam size, these transmission beams will not overlap in the output space and their contribution to the constructive interference process is lost. Therefore, when the AOI is large, the ratio of walk-off size to beam diameter becomes an important parameter that needs to be minimized. If the beam size is too small, the performance of the filter is degraded. Namely, the filter shape (i.e., the frequency transmission profile of the passband) is poor and insertion losses increases. Thus, to reduce the effect of walk-off on the filter performance, a large beam size (about or greater than 2 mm) has been used as a necessity in the art. For example, a 2-mm beam can provide a condition of sufficient multiple beam interference to significantly reduce the effects of walk-off on filter shape at incident angles of 20 degrees and greater for a passband of 1,525 to 1,565 nm.

In addition, because at large angles of incidence the transmission functions of the P- and S-polarization states are very different, it is preferred to use a polarization converter to split and convert the incident beam into two parallel beams having the same polarization state, as described in U.S. Pat. No. 6,909,549. This enables the filter to receive essentially all the radiating energy of the input beam. If the incident beam has a circular Gaussian profile with a diameter of 2 mm, for instance, the distance of the two parallel beams produced by the converter should be slightly greater than 2 mm in order to produce the necessary separation. Therefore, the area of the filter must be at least 2×4 mm (without considering the edge effect of the filter). In addition, the collimator (producing the incident beam), the polarization converter, and the filter need to be matched in size accordingly. As a result, their combined size is not only very bulky, but also requires a large filter having a uniform performance over the large area, which is difficult to achieve.

In view of the foregoing, there is a need for a tunable filter structure that allows the use of a smaller input beam without the detrimental walk-off effects described above. This invention provides a practical solution based on an innovative use of shaping prisms.

### SUMMARY OF THE INVENTION

The invention is based on the combination of a conventional interference tunable filter with a shaping prisms assembly that enlarges the circular input beam in the direction orthogonal to the direction of beam propagation and to the axis of rotation of the tunable filter. The degree of expansion is tailored to minimize the walk-off losses produced by successive reflections in the cavity of the tunable filter. By appropriately sizing the enlargement, the substantially elliptical beam produced by the shaping prisms will encompass sufficient reflected beams after passing through the tunable filter to produce substantially the same filter output that could be achieved with conventional filter and a materially larger input beam.

In the preferred embodiment of the invention, the input beam is first converted to two parallel beams of the same polarization state. Both beams are then expanded by the prisms assembly and processed by the tunable filter.

Various other advantages will become clear from the description of the invention in the specification that follows and from the novel features particularly pointed out in the appended claims. Therefore, to the accomplishment of the objectives described above, this invention consists of the features hereinafter illustrated in the drawings, fully described in the detailed description of the preferred embodiments, and particularly pointed out in the claims. However, such drawings and descriptions disclose only some of the various ways in which the invention may be practiced.

### BRIEF DESCRIPTION OF THE DRAWINGS

FIG. 1 shows schematically a single-cavity interference tunable filter to illustrate the walk-off produced by successive reflections within the cavity when the input beam impinges with a non-zero angle of incidence.

FIG. 2 is an elevational schematic diagram showing the combination of a polarization converter, a shaping prism assembly, and a narrow-band interference filter according to the invention.

FIG. 3 is a perspective schematic view of the tunable filter of FIG. 2.

FIG. 4 is an illustration of the beam size at different locations of the optical train of a conventional tunable filter designed to produce a particular output and the corresponding minimum dimension required for the filter.

FIG. 5 is an illustration of the beam size at different locations of the optical train of a tunable filter according to the invention designed to produce substantially the same output of the conventional filter of FIG. 4.

### DETAILED DESCRIPTION OF THE INVENTION

The term “anamorphic” is used in the art to refer to optical systems that intentionally distort, such as anamorphic lenses that produce unequal magnification along perpendicular axes. As such, anamorphic shaping prisms have been used to improve the shape of a light beam, such as to circularize the elliptical output of diode lasers. Their structures and corresponding optical functions are well known in the art. See, for example, the anamorphic prism pairs sold by Thorlabs as Part PS872-B, or by Edmund Optics as Part NT47-244.

The present invention is based on the idea of combining such shaping prisms with existing interference tunable-filter technology in order to increase the size of the output beam in one direction to the degree necessary to include sufficient transmission reflections to maintain the desired quality of the output profile. As a result of the beam expansion, an acceptable performance of the tunable filter can be achieved with an overall size that is significantly smaller than necessary to produce the same result with a conventional system configuration.

Accordingly, a pair of anamorphic prisms can be used to change the shape of the input beam by expanding it in a direction perpendicular to the direction of propagation and to the axis of rotation of the tunable filter, thereby converting the typically circular laser beam into an elliptical beam. The filter size is tailored to accommodate the size of the expanded beam.

According to the preferred embodiment of the invention, the input beam to the tunable filter, such as a circular laser beam I traveling in the Z direction, is first passed through a polarization converter 10 to produce two equally polarized, parallel beams traveling in the same direction, as illustrated in FIG. 2 (where both beams lie on the X-Z plane; therefore, only one beam is shown). A pair of prisms 12,14 is utilized in conventional manner to expand both parallel beams in the Y direction to the degree deemed necessary in order for the filter output beams to include a sufficient number of reflected interferences to produce an acceptable filter shape. The expanded pair of beams is then processed through the filter 16 in conventional manner. Note that the filter is tunable by rotation around the axis x, which is parallel to the X axis in the coordinate system used in the description.

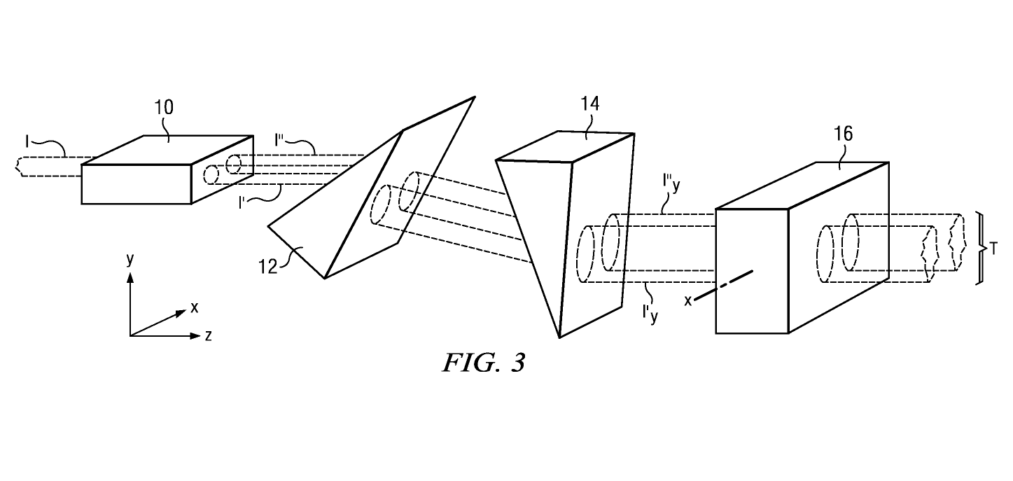

FIG. 3 illustrates the same arrangement in perspective view. The input beam I and the parallel beams I′ and I″ produced by the polarization converter 10 have a circular shape before they hit the prism assembly 12, 14. The anamorphic prisms expand the beams in the Y direction while maintaining the beam size in the X direction, as illustrated. Therefore, the output beams I_{Y}′ and I_{Y}″ become substantially elliptical beams. For instance, a 0.6 mm circular beam can be expanded to 2.0 mm in the Y direction (the major axis or transverse diameter of the ellipse) and maintain a 0.6 mm width in the X direction (the minor axis or conjugate diameter of the ellipse).

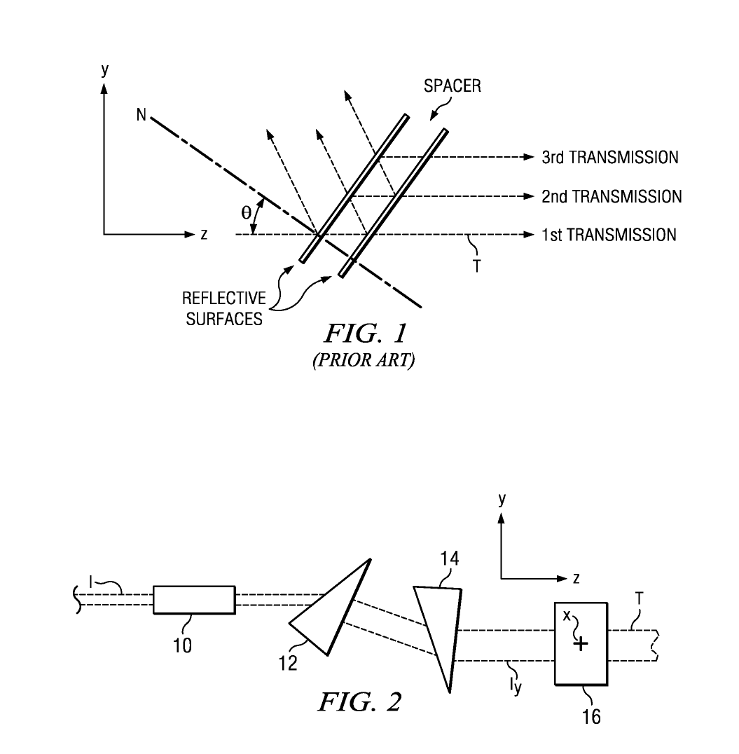

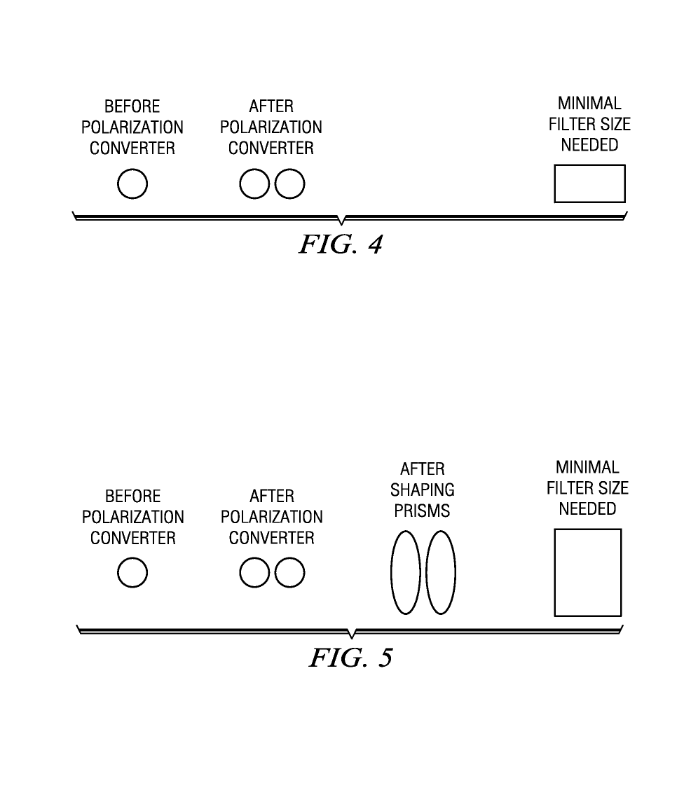

As seen in FIG. 1, when the filter 16 is rotated about its axis of rotation x (which is perpendicular to the paper and parallel to the coordinate X axis), the walk-off occurs along the Y direction. Therefore, by using a shaping-prism assembly to expand the beam in the Y direction, as taught by the invention, the output of the filter is affected considerably less by walk-off. For example, by expanding a 0.6-mm circular beam to 2.0 mm (e.g., by a factor of 3), the filter is functioning effectively as a conventional filter working with a 2.0-mm circular input beam. However, such a conventional filter requires not only a 2.0-mm input beam, but also a converter large enough to process such beam and a filter of commensurate size, as illustrated in FIG. 4. By incorporating the shaping prisms of the invention, the same output can be obtained with a much smaller input beam (⅓ in diameter), a similarly smaller converter, and a tunable filter that is also only ⅓ in size, as shown in FIG. 5. Therefore, the invention affords a very desirable miniaturization and, in particular, it allows the use of a smaller filter area, which improves filter uniformity and performance.

In dense-wavelength division-multiplexing (DWDM) applications, the width of the stop band of a filter is a critical parameter because a wider stop band can leak power from adjacent channels into the transmitting channel, and hence it can affect performance. For instance, a 50 G DWDM system has a pass bandwidth greater than 20 GHz, which, at 1528-nm wavelength, is equivalent to having a pass bandwidth greater than 156 pm (or a stop bandwidth less than 623 pm). At 1568 nm wavelength, the corresponding bandwidths are 164 pm and 656 pm, respectively. This standard stop-bandwidth requirement is difficult to achieve in a filter at large angles of incidence because the destructive interference of the multiple reflected beams determines the stop bandwidth. When the filter is positioned at large angles, the interference becomes incomplete due to beam walk-off. This incomplete interference can result in a change in the transmission profile, especially with respect to the stop bandwidth. At the extreme, when the walk-off is greater than the beam size, the reflected beams will no longer overlap to interfere.

For a filter at an AOI equal to zero degrees, for instance, the width of the stop band (at 20 dB) is 0.41 nm at 1568-nm wavelength. At a large AOI, the transmission wavelength shifts from 1568 nm to 1528 nm. The width of the stop band (at 20 dB) obtained with a conventional tunable filter designed for an input beam of circular 0.6-mm cross-section becomes 0.63 nm. This width can barely meet the typical stop-bandwidth specification requirements, but without any margin. In contrast, with the same filter the width of the stop band (at 20 dB) obtained by incorporating a pair of shaping prism according to the invention to expand the input beam to 2 mm in the Y direction is reduced from 0.63 nm to 0.54 nm. This comparison illustrates the significant improvement in the stop-band filter profile produced by expanding the beam.

While the invention has been shown and described in what are believed to be the most practical and preferred embodiments, it is recognized that departures can be made therefrom within the scope of the invention. For example, the invention has been described in terms of anamorphic prisms, but those skilled in the art will readily understand that the invention could be implemented with other anamorphic optical systems, such as a telescope with anamorphic cylindrical lenses. Therefore, the invention is not to be limited to the details disclosed herein, but is to be accorded the full scope of the claims so as to embrace any and all equivalent apparatus and methods.

What is claimed is:

1. An interference tunable filter comprising:
a polarization converter producing two parallel beams from an input beam, said parallel beams having equal polarization states;
an anamorphic optical system receiving the parallel beams and expanding them to produce expanded beams; and
an interference tunable filter receiving said expanded beams;
wherein the expanded beams are expanded by the anamorphic optical system in a direction orthogonal to a direction of propagation of the parallel beams and orthogonal to an axis of rotation of the tunable filter.

2. The tunable filter of claim 1, wherein said anamorphic optical system is a prism assembly.

3. The tunable filter of claim 2, wherein said prism assembly includes two prisms.

4. The tunable filter of claim 2, wherein said input beam is a substantially circular laser beam and said expanded beams are substantially elliptical.

5. The tunable filter of claim 2, wherein said input beam is a substantially circular laser beam with a diameter of about 0.6 mm and said expanded beams are substantially elliptical beams with an expanded transverse diameter of about 2 mm.

6. The tunable filter of claim 2, wherein said anamorphic prism assembly includes two prisms, said input beam is a substantially circular laser beam with a diameter of about 0.6 mm, and said expanded beams are substantially elliptical beams with an expanded transverse diameter of about 2 mm.

7. In an interference tunable filter comprising a polarization converter producing two parallel beams and an interference filter receiving said parallel beams, the improvement comprising:
an anamorphic prism assembly expanding said parallel beams to produce expanded beams;
wherein the expanded beams are expanded in a direction orthogonal to a direction of propagation of the parallel beams and orthogonal to an axis of rotation of the tunable filter.

8. The tunable filter of claim 7, wherein said anamorphic prism assembly includes two prisms.

9. The tunable filter of claim 7, wherein said input beam is a substantially circular laser beam and said expanded beams are substantially elliptical.

10. The tunable filter of claim 7, wherein said input beam is a substantially circular laser beam with a diameter of about 0.6 mm and said expanded beams are substantially elliptical beams with an expanded transverse diameter of about 2 mm.

11. The tunable filter of claim 7, wherein said anamorphic prism assembly includes two prisms, said input beam is a substantially circular laser beam with a diameter of about 0.6 mm, and said expanded beams are substantially elliptical beams with an expanded transverse diameter of about 2 mm.

12. A method of filtering a light beam with an interference tunable filter, the method comprising the following steps:
converting an input beam into two parallel beams having equal polarization states;
expanding the parallel beams to produce expanded beams; and
filtering the expanded beams with an interference tunable filter;
wherein the expanded beams are expanded in a direction orthogonal to a direction of propagation of the parallel beams and orthogonal to an axis of rotation of the tunable filter.

13. The method of claim 12, wherein said expanding step is carried out with two anamorphic prisms.

14. The method of claim 12, wherein said input beam is a substantially circular laser beam and said expanded beams are substantially elliptical.

15. The method of claim 12, wherein said input beam is a substantially circular laser beam with a diameter of about 0.6 mm and said expanded beams are substantially elliptical beams with an expanded transverse diameter of about 2 mm.

16. The method of claim 12, wherein said expanding step is carried out with two anamorphic prisms, said input beam is a substantially circular laser beam with a diameter of about 0.6 mm, and said expanded beams are substantially elliptical beams with an expanded transverse diameter of about 2 mm.
